(19) United States
(12) Patent Application Publication
(10) Pub. No.: US 2025/0147304 A1
(43) Pub. Date: May 8, 2025

(54) OPTICAL SCANNING SYSTEM

(71) Applicant: NALUX CO., LTD., Osaka (JP)

(72) Inventors: Jumpei ODA, Osaka (JP); Tomohito KUWAGAITO, Osaka (JP)

(73) Assignee: NALUX CO., LTD., Osaka (JP)

(21) Appl. No.: 19/018,511

(22) Filed: Jan. 13, 2025

Related U.S. Application Data
(63) Continuation of application No. PCT/JP2022/036445, filed on Sep. 29, 2022.

(51) Int. Cl. G02B 26/12; B41J 2/447; B41J 2/47; G03G 15/04; G03G 15/043

(52) U.S. Cl. CPC G02B 26/125; G02B 26/123; B41J 2/447; B41J 2/473; G03G 15/04036; G03G 15/0435

(57) ABSTRACT

An optical scanning system comprising first and second light sources emitting first and second light beams, a polygon mirror and first to fourth scanning lenses, wherein when an x-axis is in a direction of the central axis of the polygon mirror, a y-axis is in a scanning direction, P1 and P2 respectively represent reference points of deflection of the first and second light beams, L1 and L2 respectively represent a distance between P1 and the first scanning lens and a distance between P2 and the second scanning lens, Lp12 represents a distance between P1 and P2, h1 and h2 respectively represent thicknesses of the first and second scanning lenses and each of θ1 and θ2 represent an acute angle between a projection of the principal ray each of the first and second light beams onto an x-y plane,

$$\frac{h 2}{2.2} \leq ( 2 \cdot L 1 + L 2 + {L}_{p 12} ) \cdot tan θ1 \\ \frac{h 1}{2.2} \leq ( 2 \cdot L 2 + L 1 + {L}_{p 12} ) \cdot tan θ 2$$

are satisfied.

### CROSS REFERENCE TO RELATED APPLICATION

This is a Continuation of International Patent Application No. PCT/JP2022M36445 filed Sep. 29, 2022, which designates the U.S. The contents of this application is hereby incorporated by reference.

### TECHNICAL FIELD

The present invention relates to an optical scanning system that uses plural light beams to scan plural surfaces to be scanned with the light beams.

### BACKGROUND ART

Optical scanning systems in which plural light beams are directed at a polygon mirror to scan plural surfaces to be scanned with the light beams are used. In such optical scanning systems, scanning lenses, each of which is used for converging each of light beams, are placed such that they are symmetrical about the polygon mirror. In such optical scanning systems, a portion of a light beam is reflected by a scanning lens and reaches, as spray light, a surface that is designed to be scanned by another light beam and that is placed on the opposite side of the polygon mirror from a surface that is designed to be scanned by the light beam. The spray light can cause a problem of a stripe and/or other type of printing of poor quality.

In order to solve the above-described problem, an optical scanning system provided with a shading member placed between the polygon mirror and scanning lenses has been developed (Patent document 1). The shading member in the optical scanning system, however, makes the structure more complicated and increases the production cost. Further, a surface of a scanning lens on which a light beam is reflected must be convex towards the polygon mirror and therefore a lateral magnification in the sub-scanning direction is made greater, which increases error sensitivity of shapes and positions of lenses.

Until now, an optical scanning system that uses plural light beams to scan plural surfaces to be scanned with the light beams, the optical scanning system being simple in structure and having no rigid constraints on the shape of a surface of each scanning lens, has not been developed.

Accordingly, there is a need for an optical scanning system that uses plural light beams to scan plural surfaces to be scanned with the light beams, the optical scanning system being simple in structure and having no rigid constraints on the shape of a surface of each scanning lens.

### PRIOR ART DOCUMENT

Patent document 1: JP2014206673 (A)

The object of the present invention is to provide an optical scanning system that uses plural light beams to scan plural surfaces to be scanned with the light beams, the optical scanning system being simple in structure and having no rigid constraints on the shape of a surface of each scanning lens.

### SUMMARY OF THE INVENTION

An optical scanning system according to the present invention includes first and second light sources, a polygon mirror and first to fourth scanning lenses and is configured such that a first light beam emitted by the first light source is reflected by the polygon mirror and passes through the first scanning lens and the third scanning lens and a second light beam emitted by the second light source is reflected by the polygon mirror and passes through the second scanning lens and the fourth scanning lens. When A1 represents the vertex of the object-side surface of the first scanning lens, A2 represents the vertex of the object-side surface of the second scanning lens, an x-axis is defined to be in a direction of the central axis of the polygon mirror, a y-axis is defined to be in a scanning direction of the light beams, a z-axis is defined to be orthogonal to the x-axis and the y-axis, P1 represents a reference point of deflection of the first light beam, P2 represents a reference point of deflection of the second light beam, L1 represents a distance in the z-axis direction between the point P1 and the point A1, L2 represents a distance in the z-axis direction between P2 and A2, Lp12 represents a distance in the z-axis direction between P1 and P2, h1 represents a thickness in the x-axis direction of the first scanning lens, h2 represents a thickness in the x-axis direction of the second scanning lens, θ1 represents an acute angle that a projection of the principal ray of the first light beam onto a plane containing the x-axis and the y-axis forms with the y-axis and θ2 represents an acute angle that a projection of the principal ray of the second light beam onto a plane containing the x-axis and the y-axis forms with the y-axis,

$$\frac{h 2}{2.2} \leq ( 2 \cdot L 1 + L 2 + {L}_{p 12} ) \cdot tan θ 1 \\ and \\ \frac{h 1}{2.2} \leq ( 2 \cdot L 2 + L 1 + {L}_{p 12} ) \cdot tan θ2$$

are satisfied. The optical scanning system is configured such that a light beam emitted by each light source is substantially focused at each reference point of deflection in the direction corresponding to the x-axis direction of the light beam on each surface to be scanned and a lateral magnification in the x-axis direction from each reference point of deflection to each surface to be scanned is in a range from 2 to 3.

In the optical scanning system according to the present invention, the first and second scanning lenses are placed such that the inequalities described above are satisfied. Accordingly, influence of spray light caused by one of the first and second light beams on a surface that is designed to be scanned by the other light beam and that is placed on the opposite side of the polygon mirror from a surface that is designed to be scanned by the one light beam, remains at an acceptable level and the spray light does not generate a stripe and/or other type of printing of poor quality.

In the optical scanning system according to a first embodiment of the present invention, the shape of the first scanning lens and the shape of the second scanning lens are identical with each other and are placed such that they are symmetric about the plane that is parallel to the x-axis and the y-axis and contains a point O that is the middle point of a line segment connecting the point A1 and the point A2, and the shape of the third scanning lens and the shape of the fourth scanning lens are identical with each other and are placed such that they are symmetric about the plane that is parallel to the x-axis and the y-axis and contains the point O.

In the optical scanning system according to a second embodiment of the present invention, each of the third scanning lens and the fourth scanning lens includes two lenses stacked in the x-axis direction, each of the two lenses having an object-side surface and an image-side surface.

In the optical scanning system according to a third embodiment of the present invention, the object-side surface of each of the first scanning lens and the second scanning lens is not a concave surface, of which an average value of absolute values of radius of curvature in an area on which a light beam is reflected in a cross section cut by an x-z plane is 200 millimeters or smaller.

Since in the optical scanning system according to the present embodiment, the object-side surface of each of the first scanning lens and the second scanning lens is not a concave surface, of which an average value of absolute values of radius of curvature in an area on which a light beam is reflected in a cross section cut by an x-z plane is 200 millimeters or smaller, an increase in illuminance caused by one of the first and second light beams reflected on the object side surface of the corresponding scanning lens, on a surface that is designed to be scanned by the other light beam and that is placed on the opposite side of the polygon mirror from a surface that is designed to be scanned by the one light beam is restrained so that influence of the spray light can be limited.

The optical scanning system according to a fourth embodiment of the present invention further includes a third and a fourth light sources and is configured such that a third light beam emitted by the third light source is reflected by the polygon mirror and passes through the first scanning lens and the third scanning lens and a fourth light beam emitted by the fourth light source is reflected by the polygon mirror and passes through the second scanning lens and the fourth scanning lens. A reference point of deflection of the third light beam agrees with P1, a reference point of deflection of the fourth light beam agrees with P2 and when θ3 represents an acute angle that a projection of the principal ray of the third light beam onto a plane containing the x-axis and the y-axis forms with the y-axis and θ4 represents an acute angle that a projection of the principal ray of the fourth light beam onto a plane containing the x-axis and the y-axis forms with the y-axis,

$$\frac{h 2}{2.2} \leq ( 2 \cdot L 1 + L 2 + {L}_{p 12} ) \cdot tan θ3 \\ \frac{h 1}{2.2} \leq ( 2 \cdot L 2 + L 1 + {L}_{p 12} ) \cdot tan θ4$$

are satisfied. A light beam emitted by each light source is substantially focused at each reference point of deflection in the direction corresponding to the x-axis direction of the light beam on each surface to be scanned and a lateral magnification in the x-axis direction from each reference point of deflection to each surface to be scanned is in a range from 2 to 3.

In the optical scanning system according to the present embodiment, the first and second scanning lenses are placed such that the inequalities described above are satisfied. Accordingly, influence of spray light caused by one of the third and fourth light beams reflected on the object side surface of the corresponding scanning lens, on a surface that is designed to be scanned by the other light beam and that is placed on the opposite side of the polygon mirror from a surface that is designed to be scanned by the one light beam, remains at an acceptable level and the spray light does not generate a stripe and/or other type of printing of poor quality.

In the optical scanning system according to a fifth embodiment of the present invention, an effective scan size on each surface to be scanned of each of the light beams emitted by the light sources is 230 millimeters or smaller.

The optical scanning system according to a sixth embodiment of the present invention further includes an element for receiving light placed between each light source and the polygon mirror and is configured such that a light beam is converged in the direction corresponding to the y-axis direction of the light beam on each surface to be scanned after having passed through the element for receiving light.

### BRIEF DESCRIPTION OF DRAWINGS

FIG. 1 shows a perspective view of an optical scanning system according to an embodiment of the present invention;

FIG. 2 shows a plan view of the optical scanning system according to the embodiment of the present invention;

FIG. 3 shows a plan view of a path of alight beam emitted by the third light source in an optical scanning system according to a comparative example that will be described later;

FIG. 4 shows a side view of the path of the light beam emitted by the third light source in the optical scanning system according to the comparative example that will be described later;

FIG. 5 is an enlarged drawing of a portion of FIG. 2, the portion including the polygon mirror, the first scanning lens and the second scanning lens;

FIG. 6 shows a projection of a path of the principal ray of a light beam emitted by the first light source onto a plane containing the x-axis and the y-axis;

FIG. 7 shows positions on a cross section cut by a plane that contains the point A and is perpendicular to the Z-axis, through the positions each of alight beam emitted by the first light source 101 and a light beam emitted by the third light source 103 passing;

FIG. 8 is a plan view of an optical scanning system according to an example described later, the plan view showing a path of a light beam emitted by the third light source;

FIG. 9 is a side view of the optical scanning system according to the example described later, the plan view showing the path of the light beam emitted by the third light source;

FIG. 10 shows positions of beam waist in the main-scanning direction (the y-axis direction) and the sub-scanning direction (the x-axis direction) of the optical scanning system according to Example; and

FIG. 11 shows a position of beam waist in the main-scanning direction (the y-axis direction) and the sub-scanning direction (the x-axis direction) of the optical scanning system according to Comparative Example.

### DESCRIPTION OF EMBODIMENTS

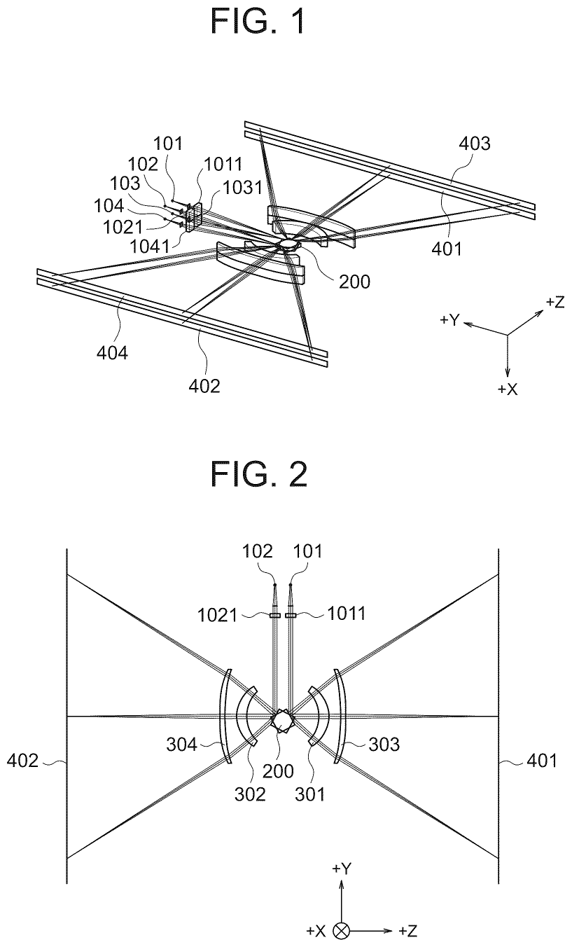

FIG. 1 shows a perspective view of an optical scanning system according to an embodiment of the present invention.

FIG. 2 shows a plan view of the optical scanning system according to the embodiment of the present invention.

In an optical scanning system according to the present invention, plural light beams are directed at a single polygon mirror to scan plural surfaces to be scanned. In the embodiment shown in FIGS. 1 and 2, four light beams emitted by four light sources are directed at a single polygon mirror. A first optical scanning system includes a first light source 101, a first aperture stop, a first element for receiving light 1011, a polygon mirror 200, a first scanning lens 301 and a third scanning lens 303. A second optical scanning system includes a second light source 102, a second aperture stop, a second element for receiving light 1021, the polygon mirror 200, a second scanning lens 302 and a fourth scanning lens 304. A third optical scanning system includes a third light source 103, a third aperture stop, a third element for receiving light 1031, the polygon mirror 200, the first scanning lens 301 and a third scanning lens 303. A fourth optical canning system includes a fourth light source 104, a fourth aperture stop, a fourth element for receiving light 1041, the polygon mirror 200, the second scanning lens 302 and the fourth scanning lens 304. In other words, the polygon mirror 200 is shared by the first to the fourth optical scanning systems, the first scanning lens 301 and the third scanning lens 303 are shared by the first optical scanning system and the third optical scanning system and the second scanning lens 302 and the fourth scanning lens 304 are shared by the second optical scanning system and the fourth optical scanning system.

An x-axis is defined to be in a direction of the rotation axis of the polygon mirror 200, a y-axis is defined to be in a scanning direction of each light beam and a z-axis is defined to be orthogonal to the x-axis and the y-axis. The directions of the x-axis, the y-axis and the z-axis are shown in FIGS. 1 and 2. The direction of the y-axis is also referred to as a main-scanning direction and the direction of the x-axis is also referred to as a sub-scanning direction.

In the first optical scanning system, a light beam emitted by the first light source 101 passes through the first aperture stop and the first element for receiving light 1011, is reflected by a face of the polygon mirror 200, passes through the first scanning lens 301 and the third scanning lens 303 and then is focused on a surface 401 to be scanned. In the second optical scanning system, alight beam emitted by the second light source 102 passes through the second aperture stop and the second element for receiving light 1021, is reflected by a face of the polygon mirror 200, passes through the second scanning lens 302 and the fourth scanning lens 304 and then is focused on a surface 402 to be scanned. In the third optical scanning system, a light beam emitted by the third light source 103 passes through the third aperture stop and the third element for receiving light 1031, is reflected by a face of the polygon mirror 200, passes through the first scanning lens 301 and the third scanning lens 303 and then is focused on a surface 403 to be scanned. In the fourth optical scanning system, a light beam emitted by the fourth light source 104 passes through the fourth aperture stop and the fourth element for receiving light 1041, is reflected by a face of the polygon mirror 200, passes through the second scanning lens 302 and the fourth scanning lens 304 and then is focused on a surface 404 to be scanned. Each optical scanning system is so configured that a light beam emitted by each light source is substantially focused at a point of reflection on a face of the polygon mirror 200 in the direction corresponding to the x-axis direction of the beam on the surface to be scanned and converged after having passed through each element for receiving light in the direction corresponding to the y-axis direction of the beam on the surface to be scanned. Each element for receiving light is an anamorphic element (an anamorphic lens). In each optical system, a section from each light source to the polygon mirror is referred to as an optical system for receiving light and a section from the polygon mirror to each surface to be scanned is referred to as an imaging optical system.

In the present embodiment, the shape of the polygon mirror 200 in a cross section cut by a plane perpendicular to the x-axis is square. In other embodiments, the shape of the polygon mirror in a cross section cut by a plane perpendicular to the x-axis can be hexagonal, octagonal or the like.

In general, the present invention is applicable to a compact optical scanning system in which lateral magnification in the sub-scanning direction from the point of reflection on a face of the polygon mirror to the surface to be scanned is in a range from 2 to 3 and an effective scan length is 230 millimeters or smaller.

Stray light caused by reflection of a light beam on the object-side surface of a scanning lens will be described below.

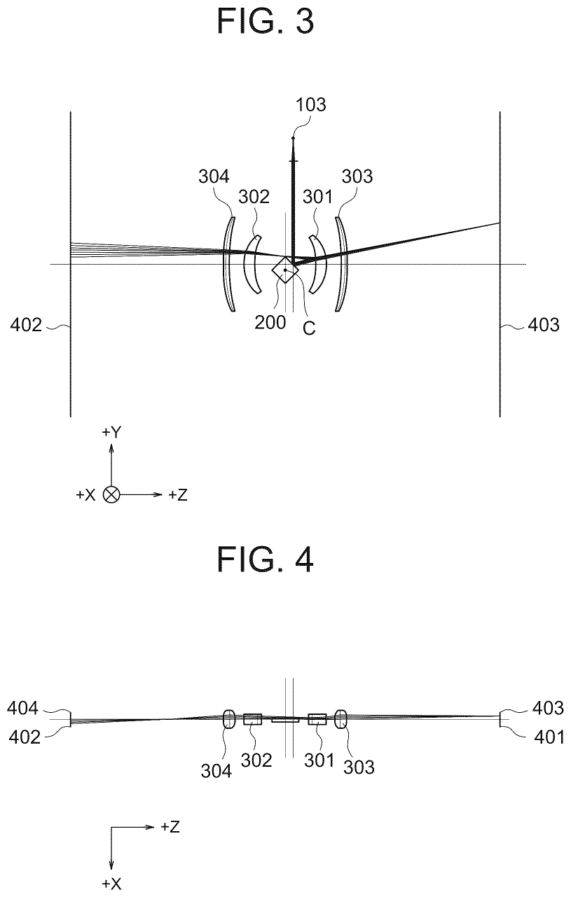

FIG. 3 shows a plan view of a path of a light beam emitted by the third light source 103 in an optical scanning system according to a comparative example that will be described later. FIG. 3 shows a cross section cut by a plane parallel to the y-axis and the z-axis. Reference numerals of elements such as a light source used in the comparative example are identical with those used in the embodiment shown in FIG. 1 and FIG. 2.

FIG. 4 shows a side view of the path of the light beam emitted by the third light source 103 in the optical scanning system according to the comparative example that will be described later. FIG. 4 shows a cross section cut by a plane parallel to the x-axis and the z-axis.

As described above, a light beam emitted by the third light source 103 passes through the third aperture stop and the third element for receiving light 1031, is reflected by a face of the polygon mirror 200, passes through the first scanning lens 301 and the third scanning lens 303 and then is focused on the surface 403 to be scanned. A portion of the light beam, however, is reflected on the object-side surface of the first scanning lens 301, passes through the second scanning lens 302 and the fourth scanning lens 304 and then reaches the surface 402 to be scanned as stray light. According to FIG. 4, all of the light beam that has been reflected on the object-side surface of the first scanning lens 301 reaches the surface 402 to be scanned as stray light after having passed through the second scanning lens 302 and the fourth scanning lens 304.

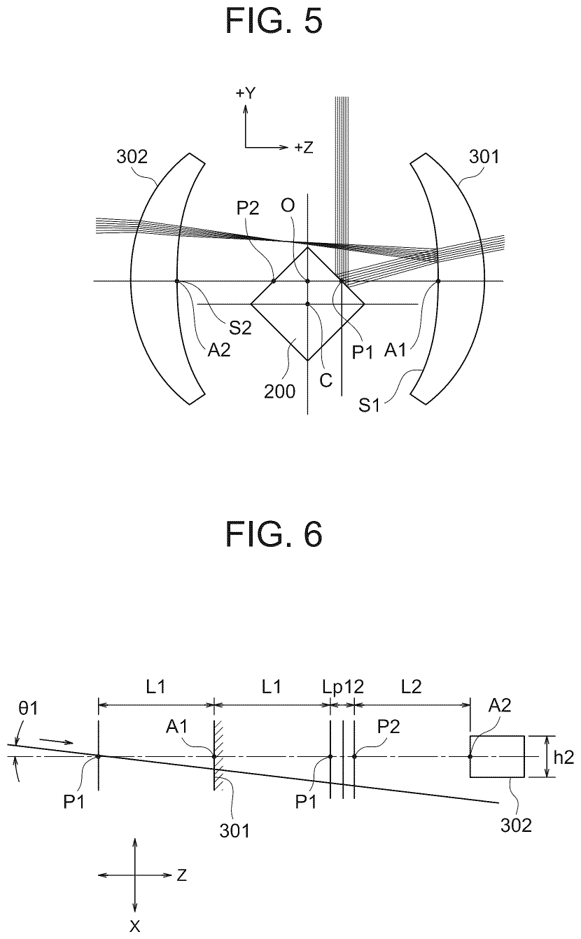

FIG. 5 is an enlarged drawing of a portion of FIG. 3, the portion including the polygon mirror 200, the first scanning lens 301 and the second scanning lens 302. The vertex of the object-side surface of the first scanning lens 301 is represented by A1, the vertex of the object-side surface of the second scanning lens 302 is represented by A2 and the midpoint of the line segment connecting the point A1 and the point A2 is represented by O. The first scanning lens 301 and the second scanning lens 302 are place such that the straight line connecting the point A1 and the point A2 is in the direction of the z-axis. A reference point of deflection of a light beam emitted by the first light source 101 is represented by P1 and a reference point of deflection of a light beam emitted by the second light source 102 is represented by P2. In general, a reference point of deflection refers to a point of reflection of the principal ray of a light beam that has been emitted by a light source and has reached a deflector (a polygon mirror) when a projection of the principal ray of the light beam reflected by the deflector onto a plane containing the y-axis and the z-axis is orthogonal to the y-axis. The optical system is configured such that the reference point of deflection P1 and the reference point of deflection P2 are located on the straight line connecting the point A1 and the point A2.

FIG. 6 shows a projection of a path of the principal ray of a light beam emitted by the first light source 101 onto a plane containing the x-axis and the y-axis. In FIG. 6 the path of the principal ray is expressed such that a travelling direction of the principal ray is not changed by reflection on a face of the polygon mirror and on the object-side surface of the first scanning lens 301. A distance between the point P1 and the point A1 in the z-axis direction is represented by L1, a distance between the point P2 and the point A2 in the z-axis direction is represented by L2 and a distance between the point P1 and the point P2 in the z-axis direction is represented by Lp12. An acute angle that a projection of a path of the principal ray of a light beam that has been emitted by the first light source 101 and reaches the polygon mirror 200 onto a plane containing the x-axis and the y-axis forms with the y-axis is represented by θ1. A thickness in the x-axis direction of the second scanning lens 302 is represented by h2.

Actually, a coordinate of a position of the object-side surface of the second scanning lens 302 shown in FIG. 6 varies depending on coordinate of y of the position and is different from the coordinate of a position of the object-side surface of the second scanning lens 302 on the straight line that passes through the point O and is parallel to the z-axis. In FIG. 6, however, the difference described above is ignored.

The principal ray of alight beam that has been emitted by the first light source 101 and has been reflected on the object-side surface of the first canning lens 301 does not reach the object-side surface of the second scanning lens 302 when the following inequality is satisfied.

$$\frac{h 2}{2} < ( 2 \cdot L 1 + L 2 + {L}_{p 12} ) \cdot tan θ1 \qquad ( 1 )$$

An acute angle that a projection of a path of the principal ray of a light beam that has been emitted by the second light source 102 and reaches the polygon mirror 200 onto a plane containing the x-axis and the y-axis forms with the y-axis is represented by θ2, an acute angle that a projection of a path of the principal ray of a light beam that has been emitted by the second light source 103 and reaches the polygon mirror 200 onto a plane containing the x-axis and the y-axis forms with the y-axis is represented by θ3 and an acute angle that a projection of a path of the principal ray of a light beam that has been emitted by the fourth light source 104 and reaches the polygon mirror 200 onto a plane containing the x-axis and the y-axis forms with the y-axis is represented by θ4. A thickness in the x-axis direction of the first scanning lens 301 is represented by h1. Then, the principal ray of alight beam that has been emitted by each of the second to the fourth light sources does not reach a scanning lens placed on the opposite side of the polygon mirror when each of the following inequalities is satisfied.

$$\frac{h 1}{2} < ( 2 \cdot L 2 + L 1 + {L}_{p 12} ) \cdot tan θ 2 \qquad {( 1 )}^{′}$$

$$\frac{h 2}{2} < ( 2 \cdot L 1 + L 2 + {L}_{p 12} ) \cdot tan θ 3 \qquad {( 1 )}^{″}$$

$$\frac{h 1}{2} < ( 2 \cdot L 2 + L 1 + {L}_{p 12} ) \cdot tan θ 4 \qquad {( 1 )}^{′′′}$$

Thickness h1 in the x-axis direction of the first scanning lens 301 will be described below.

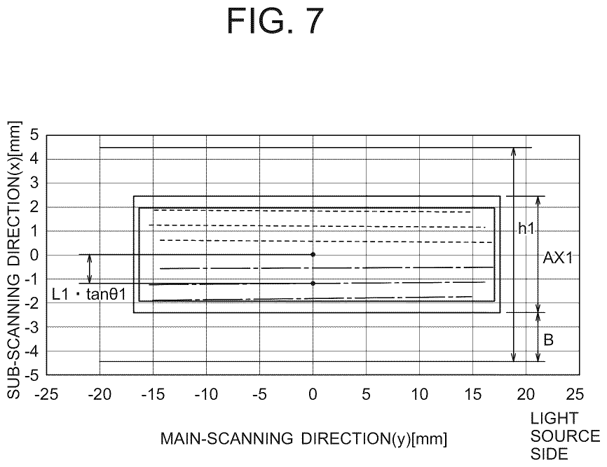

FIG. 7 shows positions on a cross section cut by a plane that contains the point A and is perpendicular to the Z-axis, through which each of a light beam emitted by the first light source 101 and alight beam emitted by the third light source 103 passes. The horizontal axis of FIG. 7 indicates coordinate in the y-axis direction. The vertical axis of FIG. 7 indicates coordinate in the x-axis direction. The unit of length is millimeter. Three broken lines indicate positions through which the light beam emitted by the first light source 101 passes. Three alternate long and short dash lines indicate positions through which light beams emitted by the third light source 103 pass. In each case, the three lines indicates positions through which the principal ray passing through the center of the aperture of the aperture stop passes and positions through which two rays passing through two apices on a diagonal of the square pass. Length in the x-axis direction of the smallest rectangle that contains all the positions through which the light beams pass is assumed to be an effective length and represented by AX1. A margin of the effective length on one side is represented by B. Then, thickness h1 in the x-axis direction of the first scanning lens 301 is expressed by the following equation.

$$h 1 = AX 1 + 2 \cdot B$$

Similarly, thickness h2 in the x-axis direction of the second scanning lens 302 is expressed by the following equation when length in the x-axis direction of the smallest rectangle that contains all the positions through which the light beams pass is assumed to be an effective length and represented by AX2.

$$h 2 = AX 2 + 2 \cdot B$$

The value of the margin B on one side of the effective length should preferably made 2 millimeters or greater in consideration of eccentricity of surfaces, incorrect positioning, adjustment of positioning and the like.

Since the thickness h2 in the x-axis direction of the second scanning lens 302 is determined as described above, the distance L1 between the point P1 and the point A1 in the z-axis direction and the distance L2 between the point P2 and the point A2 in the z-axis direction should be appropriately determined in consideration of Inequality (1).

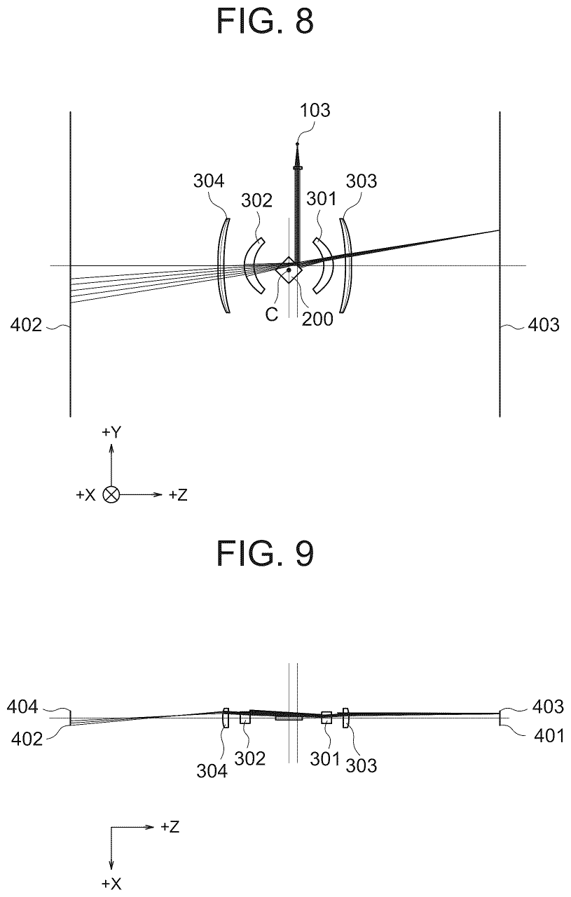

FIG. 8 is a plan view of an optical scanning system according to an example described later, the plan view showing a path of a light beam emitted by the third light source 103. FIG. 8 shows a plane parallel to the y-axis and the z-axis.

FIG. 9 is a side view of the optical scanning system according to the example described later, the plan view showing the path of the light beam emitted by the third light source 103. FIG. 9 shows a plane parallel to the x-axis and the z-axis.

According to FIG. 9, a portion of the light beam that has been reflected on the object-side surface of the first scanning lens 301 does not reach the object-side surface of the second scanning lens 302 and the other portion of the light beam is incident on the object-side surface of the second scanning lens 302 and finally reaches the surface 402 to be scanned. According to simulation, a ratio of an amount of the light beam that is incident on the object-side surface of the second scanning lens 302 to an amount of the light beam that has been reflected on the object-side surface of the first scanning lens 301 is 56.4 percent.

The object-side surface of the first scanning lens 301 is concave and divergence of alight beam reflected on the object-side surface of the first scanning lens 301 decreases with increase in the absolute value of curvature or with decrease in the absolute value of radius of curvature. As a result, illuminance on the surface 402 to be scanned increases by the influence of spray light. Accordingly, when the object-side surface of each of the first scanning lens 301 and the second scanning lens 302 is concave, the absolute value of radius of curvature should preferably be equal to or greater than a predetermined value. According to experimental results, the object-side surface of each of the first scanning lens 301 and the second scanning lens 302 should preferably be not a concave surface, of which an average value of absolute values of radius of curvature in an area on which a light beam is reflected in a cross section cut by an x-z plane of the object-side surface is 200 millimeters or smaller.

In general, influence of spray light on an surface to be scanned on the opposite side of the polygon mirror is acceptable when the following inequalities are satisfied. If the following inequalities are not satisfied, influence of spray light on a surface to be scanned is so great that a stripe and/or other type of printing of poor quality can be generated.

$$\frac{h 2}{2.2} < ( 2 \cdot L 1 + L 2 + {L}_{p 12} ) \cdot tan θ 1 \qquad ( 2 )$$

$$\frac{h 1}{2.2} < ( 2 \cdot L 2 + L 1 + {L}_{p 12} ) \cdot tan θ 2 \qquad {( 2 )}^{′}$$

$$\frac{h 2}{2.2} < ( 2 \cdot L 1 + L 2 + {L}_{p 12} ) \cdot tan θ 3 \qquad {( 2 )}^{″}$$

$$\frac{h 1}{2.2} < ( 2 \cdot L 2 + L 1 + {L}_{p 12} ) \cdot tan θ 4 \qquad {( 2 )}^{′′′}$$

The example and the comparative example of the present invention will be described below. Material of the scanning lenses is a kind of poly-cycloolefin resin and the refractive index is 1.503. Material of the elements for receiving light is a kind of poly-cycloolefin resin and the refractive index is 1.528.

In the example and the comparative example, the shape of the first scanning lens 301 and the shape of the second scanning lens 302 are identical with each other and are placed such that they are symmetric about the plane that is parallel to the x-axis and the y-axis of the scanning system and contains the point O. The shape of the third scanning lens 303 and the shape of the fourth scanning lens 304 are identical with each other and placed such that they are symmetric about the plane that is parallel to the x-axis and the y-axis of the scanning system and contains the point O. The first light source 101 and the second light source 102 are placed such that they are symmetric about the plane that is parallel to the x-axis and the y-axis of the optical system and contains the point O. The third light source 103 and the fourth light source 104 are placed such that they are symmetric about the plane that is parallel to the x-axis and the y-axis of the optical system and contains the point O. The light sources are laser diode modules.

The shape of each surface of each scanning lens will be described below. A coordinate system for each surface is defined as below. In the state in which the first to the fourth scanning lenses are placed in an optical scanning system, a z-axis is defined to be the straight line connecting the point A1 and the point A2, an origin is located at the point of intersection of the z-axis with each lens surface, an x-axis is defined to be the straight line that passes through the origin and is parallel to the x-axis of the optical system and y-axis is defined to be the straight line that passes through the origin and is parallel to the y-axis of the optical system. The direction of the z-axis is the travelling direction of light. Accordingly, when an object-side surface is concave or an image-side surface is convex, coordinates of the surface in the z-axis direction is zero or negative and when an object-side surface is convex or an image-side surface is concave, coordinates of the surface in the z-axis direction is zero or positive.

The shape of each of the object-side surface and the image-side surface of each of a set of two lenses placed closer to the point O, that is each of the first scanning lens 301 and the second scanning lens 302 in the example and the comparative example is expressed by the following equation.

$$z = \frac{\frac{{y}^{2}}{{R}_{y}}}{1 + \sqrt{1 - ( 1 + k ) \frac{{y}^{2}}{{R}_{y}^{2}}}} + {\sum }_{i = 1}^{N} {A}_{i} {y}^{i} + \frac{\frac{{x}^{2}}{{r}_{x} ( y )}}{1 + \sqrt{1 - \frac{{x}^{2}}{{{r}_{x} ( y )}^{2}}}} \\ where \\ {r}_{x} ( y ) = {r}_{x} ( 0 ) + {\sum }_{i = 1}^{N} {B}_{i} {y}^{i} \qquad ( 3 )$$

y: coordinate in the main-canning direction
x: coordinate in the sub-scanning direction
z: sag
k: conic constant
Ry: radius of curvature in a cross section cut by a plane containing the main-scanning direction
rx(y): radius of curvature in a cross section cut by a plane containing the sub-scanning direction at coordinate of y in the main-scanning direction
rx(0): radius of curvature in a cross section cut by a plane containing the sub-scanning direction on the optical axis
Ai: aspherical coefficients in a cross section cut by a plane containing the main-scanning direction (i=1, 2, 3, 4 . . . )
Bi: coefficients for determining radius of curvature in a cross section cut by a plane containing the sub-scanning direction (i=1, 2, 3, 4 . . . )

Each of a set of two lenses placed further away from the point O, that is each of the third scanning lens 303 and the fourth scanning lens 304 in the example and the comparative example includes two lenses stacked in the x-axis direction, each of the two lenses having an object-side surface and an image-side surface.

The shape of each of the object-side surface and the image-side surface of each of the third scanning lens 303 and the fourth scanning lens 304 is expressed by the following equations.

$$z = {z}_{m} + {z}_{s} \\ where \\ {z}_{m} = \frac{\frac{{y}^{2}}{{R}_{y}}}{1 + \sqrt{1 - ( 1 + {k}_{y} ) \frac{{y}^{2}}{{R}_{y}^{2}}}} + {\sum }_{i = 1}^{N} {A}_{i} {y}^{i} \\ and \\ {z}_{s} = \frac{\frac{{( x - h )}^{2}}{{r}_{x}}}{1 + \sqrt{1 - \frac{{( x - h )}^{2}}{{r}_{x}^{2}}}} + {{S}_{4} ( x - h )}^{4} \\ where \\ {r}_{x} = {r}_{0} ( 1 + {\sum }_{i = 1}^{i} {B}_{i} {y}^{i} ) , \\ h = {\sum }_{i = 0}^{i} {C}_{i} {y}^{i} \\ and \\ {S}_{4} = {\sum }_{i = 0}^{i} {D}_{i} {y}^{i} \qquad ( 4 )$$

y: coordinate in the main-scanning direction
x: coordinate in the sub-scanning direction
z: sag
zm: sag in the main-scanning direction
zs: sag in the sub-scanning direction
ky: conic constant in the main-scanning direction
Ry: radius of curvature in a cross section cut by a plane containing the main-scanning direction
h: function of base curve
rx(y): radius of curvature in a cross section cut by a plane containing the sub-scanning direction at coordinate of y in the main-scanning direction
rx(0): radius of curvature in a cross section cut by a plane containing the sub-scanning direction on the optical axis
Ai: aspherical coefficients in a cross section cut by a plane containing the main-scanning direction (i=1, 2, 3, 4 . . . )
Bi: coefficients for determining radius of curvature in a cross section cut by a plane containing the sub-scanning direction (i=1, 2, 3, 4 . . . )
Ci: coefficients of base curve (i=1, 2, 3, 4 . . . )
Di: Aspherical coefficients in a cross section cut by a plane containing the sub-scanning direction (i=1, 2, 3, 4 . . . )

Two different values are assigned to each of coefficient Ai and coefficient Bi according to a sign (+/−) of coordinate in the main-scanning direction. Api represents a value of Ai in the case that the sign is positive and Ami represents a value of Ai in the case that the sign is negative. Bpi represents a value of Bi in the case that the sign is positive and Bmi represents a value of Bi in the case that the sign is negative.

### EXAMPLE

Table 1 shows numerical data of an optical scanning system according to the Example. In Table 1 and Table 4, effective scan size W refers to length in the y-axis direction of an area to be scanned on a surface to be scanned and system focal length f refers to focal length of an optical system including an optical element for receiving light and two types of scanning lenses. In Table 1 and Table 4, concerning laser-diode light sources, θ⊥ and θ//refer respectively to angle of divergence in the direction perpendicular to layers of the laser diode and angle of divergence in the direction parallel to layers of the laser diode. In the Example and the Comparative Example, the laser-diode light sources are placed such that the direction of θ⊥ agrees with the x-axis direction. In Table 1 and Table 4, the first scanning lens and the second scanning lens are represented by lens A and the third scanning lens and the fourth scanning lens are represented by lens B.

In Table 1 and Table 4, deflector means a polygon mirror. In Table 1 and Table 4, “coordinates of center of deflector” refers to (y, z) coordinates of the central axis (represented by C in FIG. 5) of the deflector with respect to (y, z) coordinates of the reference point of deflection (represented by P1 in FIG. 5). In Table 1 and Table 4, “main angle of incidence to deflector” refers to an angle that a projection of a path of the principal ray of alight beam that has been emitted by alight source and reaches the deflector onto a plane containing the y-axis and the z-axis forms with the z-axis. In Table 1 and Table 4, “sub angle of incidence to deflector,” refers to an acute angle that a projection of a path of the principal ray of a light beam that has been emitted by a light source and reaches the deflector onto a plane containing the x-axis and the y-axis forms with the y-axis. Accordingly, “sub angle of incidence to deflector: θ in” corresponds to each of θ1 to θ4 described above.

TABLE 1

| | |
|---|---|
| Item | Unit |

(part A)

| Effective scan size: W | | mm | 216 |
|---|---|---|---|
| System focal length: f | | mm | 147.3 |
| Light source | Wavelength | nm | 785 |
| | θ⊥ | deg. | 27 |
| | θ// | deg. | 12 |
| Element for | Center thickness | mm | 3.0 |
| receiving light | Refractive index | — | 1.528 |
| | Focal length/Y (main- | mm | 20.0 |
| | scanning direction) | | |
| | Focal length/X (sub- | mm | 16.9 |
| | scanning direction) | | |
| Aperture | Shape | — | Rectangle |
| | Main-scanning direction | mm | 1.31 |
| | (half value) | | |
| | Sub-scanning direction | mm | 1.51 |
| | (half value) | | |
| Deflector | Number of faces | — | 4 |
| | Size (Circumcircle) | mm | ϕ20 |
| | Coordinate of center/Y | mm | −3.939 |
| | Coordinate of center/Z | mm | −6.061 |
| Scanning | Center thickness | mm | 7.5 |
| lens (Lens A) | Refractive index | — | 1.503 |
| Scanning | Center thickness | mm | 4.5 |
| lens (Lens B) | Refractive index | — | 1.503 |

(part B)

| | | |
|---|---|---|
| Light source to reference point of deflection | mm | 100.14 |
| Aperture to reference point of deflection | mm | 84.88 |
| Image-side surface of element for receiving | mm | 78.63 |
| light to reference point of deflection | | |
| Reference point of deflection to object-side | mm | 21.5 |
| surface of scanning lens (Lens A) | | |
| Reference point of deflection to object-side | mm | 37.93 |
| surface of scanning lens (Lens B) | | |
| Reference point of deflection to surface to be | mm | 158.07 |
| scanned | | |
| Main angle of incidence to deflector | deg. | 90.0 |
| Sub angle of incidence to deflector: θin | deg. | 3.15 |

Table 2 shows coefficients of Equation (3), which expresses the shape of each surface of the first scanning lens 301 and the second scanning lens 302. The unit of length in Table 2 is millimeter.

TABLE 2

| | Coefficients of | Coefficients of |
|---|---|---|
| Surface- | object-side | image-side |
| defining | surface | surface |
| equation | Equation (3) | Equation (3) |
| R | −54.107855 | −39.547035 |
| K | −7.751827 | −0.010018 |
| rx(0) | ∞ | 75.906789 |
| A1 | 0 | 0.000086 |
| A2 | −0.009526 | −0.008916 |
| A3 | 0 | −1.727135E−06 |
| A4 | −6.195081E−06 | −6.487754E−07 |
| A5 | 0 | −5.130989E−10 |
| A6 | −1.994307E−08 | −4.126194E−09 |
| A7 | 0 | 0 |
| A8 | 0 | 0 |
| A9 | 0 | 0 |
| A10 | 0 | 0 |
| B1 | 0 | 0.455723 |
| B2 | 0 | 0.183015 |
| B3 | 0 | −3.381622E−03 |
| B4 | 0 | −6.863498E−05 |
| B5 | 0 | −3.193464E−05 |
| B6 | 0 | 1.079967E−06 |
| B7 | 0 | 0 |
| B8 | 0 | 0 |
| B9 | 0 | 0 |
| B10 | 0 | 0 |

Table 3 shows coefficients of Equation (4), which expresses the shape of each surface of the third scanning lens 303 and the fourth scanning lens 304. The unit of length in Table 3 is millimeter.

TABLE 3

| | Area of +x | | Area of −x | |
|---|---|---|---|---|
| | Coefficients of | Coefficients of | Coefficients of | Coefficients of |
| Surface- | object-side | image-side | object-side | image-side |
| defining | surface | surface | surface | surface |
| equation | Equation (4) | Equation (4) | Equation (4) | Equation (4) |
| Ry | −189.166762 | −391.962173 | −189.166762 | −391.962173 |
| ky | 5.366685 | 1.555969 | 5.366685 | 1.555969 |
| rx0 | 39.558939 | −19.184515 | 39.558939 | −19.184515 |
| C0 | 0.65 | 0.66 | −0.65 | −0.66 |
| C1 | 0 | 0 | 0 | 0 |
| C2 | 1.769546E−03 | −4.919915E−04 | −1.769546E−03 | 4.919915E−04 |
| C4 | −2.764584E−06 | 9.942497E−07 | 2.764584E−06 | −9.942497E−07 |
| C6 | 2.895939E−09 | −1.206592E−09 | −2.895939E−09 | 1.206592E−09 |
| C8 | −1.598408E−13 | 3.689379E−13 | 1.598408E−13 | −3.689379E−13 |
| C10 | 0 | 0 | 0 | 0 |
| Ap2 | 0 | 0 | 0 | 0 |
| Ap4 | −4.039429E−07 | −2.396803E−06 | −4.039429E−07 | −2.396803E−06 |
| Ap6 | −2.420119E−10 | −2.601839E−10 | −2.420119E−10 | −2.601839E−10 |
| Ap8 | 1.320071E−13 | 8.868541E−14 | 1.320071E−13 | 8.868541E−14 |
| Ap10 | 0 | 0 | 0 | 0 |
| Am2 | 0 | 0 | 0 | 0 |
| Am4 | −4.039429E−07 | −2.484600E−06 | −4.039429E−07 | −2.484600E−06 |
| Am6 | −2.420119E−10 | −1.324232E−10 | −2.420119E−10 | −1.324232E−10 |
| Am8 | 1.320071E−13 | 4.538858E−14 | 1.320071E−13 | 4.538858E−14 |
| Am10 | 0 | 0 | 0 | 0 |
| Bp2 | 1.480854E−03 | 1.740291E−04 | 1.480854E−03 | 1.740291E−04 |
| Bp4 | −1.170964E−06 | −8.132447E−08 | −1.170964E−06 | −8.132447E−08 |
| Bp6 | 7.470121E−10 | −7.230168E−11 | 7.470121E−10 | −7.230168E−11 |
| Bm2 | 8.571317E−04 | 4.968765E−04 | 8.571317E−04 | 4.968765E−04 |
| Bm4 | −2.640431E−07 | −4.127599E−07 | −2.640431E−07 | −4.127599E−07 |
| Bm6 | 4.204876E−10 | 2.520136E−11 | 4.204876E−10 | 2.520136E−11 |
| D0 | −3.330846E−05 | −1.997634E−06 | −3.330846E−05 | −1.997634E−06 |
| D2 | 1.631707E−07 | 1.269611E−07 | 1.631707E−07 | 1.269611E−07 |
| D4 | −1.508958E−10 | −2.043339E−10 | −1.508958E−10 | −2.043339E−10 |
| D6 | 6.953984E−15 | 8.809881E−14 | 6.953984E−15 | 8.809881E−14 |

According to Table 1, the following numerical values are obtained.

L1=L2=21.5 mm

L12=12.12 mm

θ1=θ2=θ3=θ4=3.15 degrees

Accordingly, the value of the right side of each of Inequalities (2) to (2)′″ is 4.22 mm. Since h1=h2=8.9 mm, each of Inequalities (2) to (2)′″ is satisfied. Further, the object-side surface of each of the first scanning lens 301 and the second scanning lens 302 is flat in a cross section cut by an x-z plane.

As described above, a ratio of an amount of alight beam that is incident on the object-side surface of the second scanning lens 302 to an amount of the light beam that has been reflected on the object-side surface of the first scanning lens 301 is 56.4 percent. This light beam, however, does not play a great role as spray light on a surface to be scanned.

The lateral magnification in the sub-scanning direction from the reference point of deflection to the surface to be scanned of the optical scanning system is 2.90.

According to Table 1, the focal length in the main-scanning direction of the element for receiving light is 20.0 millimeters. Since a distance between the light source and the element for receiving light is 100.14-78.63=21.51 millimeters, a light beam is converged in the main-scanning direction after having passed through the element for receiving light. The main-scanning direction of a light beam refers to the main-scanning direction (the y-axis direction) of the light beam on the surface to be scanned.

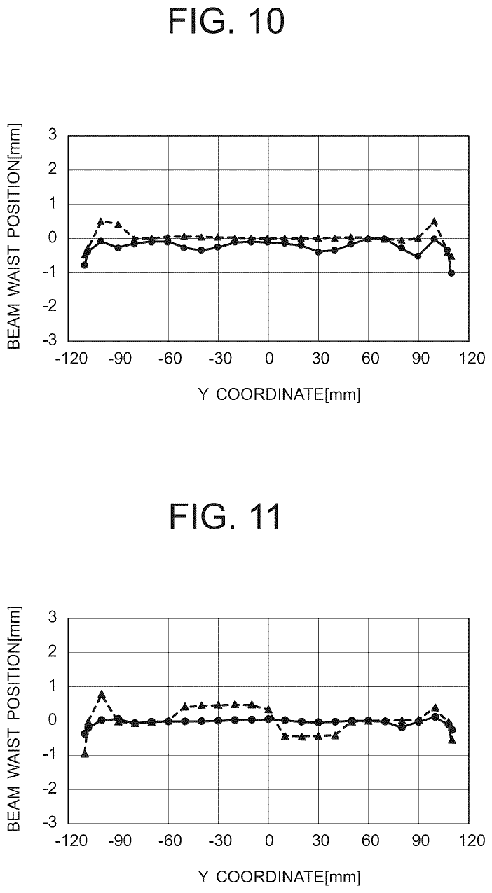

FIG. 10 shows positions of beam waist in the main-scanning direction (the y-axis direction) and the sub-scanning direction (the x-axis direction) of the optical scanning system according to the Example. A position of beam waist means the point in alight beam where the diameter is at its smallest. The horizontal axis of FIG. 10 indicates coordinate along the y-axis. The unit is millimeter. On the right side the light source is located. The vertical axis of FIG. 10 indicates a position of beam waist. The unit is millimeter. “0” on the vertical axis means that the point of beam waist is on the surface to be scanned. “−1” on the vertical axis means that the point of beam waist is 1 millimeter away from the surface to be scanned towards the polygon mirror. “1” on the vertical axis means that the point of beam waist is 1 millimeter away from the surface to be scanned towards the opposite side of the polygon mirror. The solid line in FIG. 10 represents a position of beam waist in the main-scanning direction (the y-axis direction) and the broken line in FIG. 10 represents a position of beam waist in the sub-scanning direction (the x-axis direction). According to FIG. 10, positions of beam waist are in a range from −1 millimeter to +1 millimeter and the light beam is focused in the vicinity of the surface to be scanned.

### COMPARATIVE EXAMPLE

Table 4 shows numerical data of an optical scanning system according to the Comparative example.

TABLE 4

| | |
|---|---|
| Item | Unit |

(Part A)

| Effective scan size: W | | mm | 216 |
|---|---|---|---|
| System focal length: f | | mm | 135.7 |
| Light source | Wavelength | nm | 785 |
| | θ⊥ | deg. | 27 |
| | θ// | deg. | 12 |
| Element for | Center thickness | mm | 3.0 |
| receiving light | Refractive index | — | 1.528 |
| | Focal length/Y (main- | mm | 20.0 |
| | scanning direction) | | |
| | Focal length/X (sub- | mm | 16.1 |
| | scanning direction) | | |
| Aperture | Shape | — | Rectangle |
| | Main-scanning direction | mm | 1.00 |
| | (half value) | | |
| | Sub-scanning direction | mm | 1.6 |
| | (half value) | | |
| Deflector | Number of faces | — | 4 |
| | Size (Circumcircle) | mm | ϕ20 |
| | Coordinate of center/Y | mm | −3.939 |
| | Coordinate of center/Z | mm | −6.061 |
| Scanning | Center thickness | mm | 8.0 |
| lens (Lens A) | Refractive index | — | 1.503 |
| Scanning | Center thickness | mm | 4.5 |
| lens (Lens B) | Refractive index | — | 1.503 |

(Part B)

| | | |
|---|---|---|
| Light source to reference point of deflection | mm | 101.00 |
| Aperture to reference point of deflection | mm | 85.00 |
| Image-side surface of element for receiving | mm | 80.88 |
| light to reference point of deflection | | |
| Reference point of deflection to object-side | mm | 17.5 |
| surface of scanning lens (Lens A) | | |
| Reference point of deflection to object-side | mm | 26.9 |
| surface of scanning lens (Lens B) | | |
| Reference point of deflection to surface to be | mm | 158.32 |
| scanned | | |
| Main angle of incidence to deflector | deg. | 90.0 |
| Main angle of incidence to deflector: θin | deg. | 3.0 |

Table 5 shows coefficients of Equation (3), which expresses the shape of each surface of the first scanning lens 301 and the second scanning lens 302. The unit of length in Table 5 is millimeter.

TABLE 5

| | Coefficients of | Coefficients of |
|---|---|---|
| Surface- | object-side | image-side |
| defining | surface | surface |
| equation | Equation (3) | Equation (3) |
| R | −74.774626 | −46.893232 |
| K | 5.128528 | −0.998100 |
| rx(0) | −50 | 148.797085 |
| A1 | 0 | 0.000182 |
| A2 | −0.001726 | −0.004603 |
| A3 | 0 | −3.927550E−07 |
| A4 | −2.056190E−07 | −3.550340E−06 |
| A5 | 0 | 5.058930E−10 |
| A6 | −7.125090E−09 | −3.641010E−09 |
| A7 | 0 | 2.999270E−12 |
| A8 | 5.906580E−12 | −6.076410E−12 |
| A9 | 0 | 0 |
| A10 | 0 | 0 |
| B1 | 0 | 0.198570 |
| B2 | 0 | 0.269723 |
| B3 | 0 | −0.043033 |
| B4 | 0 | 0.001016 |
| B5 | 0 | 0 |
| B6 | 0 | 0 |
| B7 | 0 | 0 |
| B8 | 0 | 0 |
| B9 | 0 | 0 |
| B10 | 0 | 0 |

Table 6 shows coefficients of Equation (4), which expresses the shape of each surface of the third scanning lens 303 and the fourth scanning lens 304. The unit of length in Table 6 is millimeter.

TABLE 6

| | Area of +x | | Area of −x | |
|---|---|---|---|---|
| | Coefficients of | Coefficients of | Coefficients of | Coefficients of |
| Surface- | object-side | image-side | object-side | image-side |
| defining | surface | surface | surface | surface |
| equation | Equation (4) | Equation (4) | Equation (4) | Equation (4) |
| Ry | −190.623634 | −179.355599 | −190.6236345 | −179.3555991 |
| ky | 2.846245 | 4.838570 | 2.846245123 | 4.838569928 |
| rx0 | 48141.512608 | −12.989794 | 48141.51261 | −12.98979376 |
| C0 | 0 | 0.652788 | 0 | −0.652787819 |
| C1 | 1.435197E−05 | −4.374820E−04 | −1.4352E−05 | 0.000437482 |
| C2 | −7.927388E−04 | 1.580639E−05 | 0.000792739 | −1.58064E−05 |
| C4 | 9.192226E−07 | −6.432926E−08 | −9.19223E−07 | 6.43293E−08 |
| C6 | −3.525163E−10 | 3.899732E−11 | 3.52516E−10 | −3.89973E−11 |
| C8 | 0 | 0 | 0 | 0 |
| C10 | 0 | 0 | 0 | 0 |
| Ap2 | 0 | 0 | 0 | 0 |
| Ap4 | 1.895870E−08 | −5.007509E−07 | 1.89587E−08 | −5.00751E−07 |
| Ap6 | 3.284820E−11 | 8.117494E−11 | 3.28482E−11 | 8.11749E−11 |
| Ap8 | −3.925640E−13 | −2.783019E−13 | −3.92564E−13 | −2.78302E−13 |
| Ap10 | 1.072210E−16 | 1.004844E−17 | 1.07221E−16 | 1.00484E−17 |
| Am2 | 0 | 0 | 0 | 0 |
| Am4 | 1.895870E−08 | −4.815593E−07 | 1.89587E−08 | −4.81559E−07 |
| Am6 | 3.284820E−11 | 6.186141E−11 | 3.28482E−11 | 6.18614E−11 |
| Am8 | −3.925640E−13 | −2.454295E−13 | −3.92564E−13 | −2.45429E−13 |
| Am10 | 1.072210E−16 | −1.977360E−18 | 1.07221E−16 | −1.97736E−18 |
| Bp2 | −1.434988E−04 | 2.983217E−04 | −0.000143499 | 0.000298322 |
| Bp4 | −2.266473E−06 | 2.784110E−08 | −2.26647E−06 | 2.78411E−08 |
| Bp6 | 1.590599E−09 | −5.732758E−11 | 1.5906E−09 | −5.73276E−11 |
| Bm2 | −1.434988E−04 | 4.149774E−04 | −0.000143499 | 0.000414977 |
| Bm4 | −2.266473E−06 | −1.945109E−08 | −2.26647E−06 | −1.94511E−08 |
| Bm6 | 1.590599E−09 | −3.154733E−11 | 1.5906E−09 | −3.15473E−11 |
| D0 | −9.082711E−05 | −5.319173E−05 | −9.08271E−05 | −5.31917E−05 |
| D2 | 3.255512E−07 | 2.056265E−07 | 3.25551E−07 | 2.05627E−07 |
| D4 | 6.847104E−11 | 2.416166E−10 | 6.8471E−11 | 2.41617E−10 |
| D6 | 0 | 0 | 0 | 0 |

According to Table 4, the following numerical values are obtained.

L1=L2=17.5 mm

L12=12.12 mm

θ1=θ2=θ3=θ4=3 degrees

Accordingly, the value of the right side of each of Inequalities (2) to (2)′″ is 3.39 mm. Since h1=h2=8 mm, any of Inequalities (2) to (2)′″ is not satisfied. Further, an average of absolute values of radius of curvature of an area where a light beam is reflected of the object-side surface of each of the first scanning lens 301 and the second scanning lens 302 is approximately 48,000 millimeters in a cross section cut by an x-z plane.

As described above, all of the light beam that has been reflected on the object-side surface of the first scanning lens 301 reaches the surface 402 to be scanned as spray light after having passed through the second scanning lens 302 and the fourth scanning lens 304. Further, since the object-side surface of the first scanning lens 301 is concave, a converged light beam reaches the surface to be scanned as spray light and has a great influence on the surface to be scanned.

The lateral magnification in the sub-scanning direction from the reference point of deflection to the surface to be scanned of the optical scanning system is 2.73.

According to Table 4, the focal length in the main-scanning direction of the element for receiving light is 20.0 millimeters. Since a distance between the light source and the element for receiving light is 101.00-80.88=20.12 millimeters, a light beam is converged in the main-scanning direction after having passed through the element for receiving light.

FIG. 11 shows positions of beam waist in the main-scanning direction (the y-axis direction) and the sub-scanning direction (the x-axis direction) of the optical scanning system according to the Comparative Example. A position of beam waist means the point in a light beam where the diameter is at its smallest. The horizontal axis of FIG. 11 indicates coordinate along the y-axis. The unit is millimeter. On the right side the light source is located. The vertical axis of FIG. 11 indicates a position of beam waist. The unit is millimeter. “0” on the vertical axis means that the point of beam waist is on the surface to be scanned. “−1” on the vertical axis means that the point of beam waist is 1 millimeter away from the surface to be scanned towards the polygon mirror. “1” on the vertical axis means that the point of beam waist is 1 millimeter away from the surface to be scanned towards the opposite side of the polygon mirror. The solid line in FIG. 11 represents a position of beam waist in the main-scanning direction (the y-axis direction) and the broken line in FIG. 11 represents a position of beam waist in the sub-scanning direction (the x-axis direction). According to FIG. 11, positions of beam waist are in a range from −1 millimeter to +1 millimeter and the light beam is focused in the vicinity of the surface to be scanned.

### Summary of Example and Comparative Example

In the Example, Inequalities (2) to (2)′″ are satisfied. Accordingly, illuminance on a surface to be scanned of a light beam that has been reflected by the object-side surface of each of the first and second scanning lenses is relatively small and has no significant influence on quality of printing. In the Comparative Example, any of Inequalities (2) to (2)′″ is not satisfied and illuminance on a surface to be scanned of alight beam that has been reflected by the object-side surface of each of the first and second scanning lenses is so great that a stripe and/or other type of printing of poor quality can be generated.

What is claimed is:

1. An optical scanning system that comprises first and second light sources, a polygon mirror and first to fourth scanning lenses and is configured such that a first light beam emitted by the first light source is reflected by the polygon mirror and passes through the first scanning lens and the third scanning lens and a second light beam emitted by the second light source is reflected by the polygon mirror and passes through the second scanning lens and the fourth scanning lens,
wherein when A1 represents the vertex of the object-side surface of the first scanning lens, A2 represents the vertex of the object-side surface of the second scanning lens, an x-axis is defined to be in a direction of the central axis of the polygon mirror, a y-axis is defined to be in a scanning direction of the light beams, a z-axis is defined to be orthogonal to the x-axis and the y-axis, P1 represents a reference point of deflection of the first light beam, P2 represents a reference point of deflection of the second light beam, L1 represents a distance in the z-axis direction between the point P1 and the point A1, L2 represents a distance in the z-axis direction between P2 and A2, Lp12 represents a distance in the z-axis direction between P1 and P2, h1 represents a thickness in the x-axis direction of the first scanning lens, h2 represents a thickness in the x-axis direction of the second scanning lens, θ1 represents an acute angle that a projection of the principal ray of the first light beam onto a plane containing the x-axis and the y-axis forms with the y-axis and θ2 represents an acute angle that a projection of the principal ray of the second light beam onto a plane containing the x-axis and the y-axis forms with the y-axis,
$$\frac{h 2}{2.2} \leq ( 2 \cdot L 1 + L 2 + {L}_{p 12} ) \cdot tan θ 1 \\ and \\ \frac{h 1}{2.2} \leq ( 2 \cdot L 2 + L 1 + {L}_{p 12} ) \cdot tan θ 2$$
are satisfied and
wherein the optical scanning system is configured such that a light beam emitted by each light source is substantially focused at each reference point of deflection in the direction corresponding to the x-axis direction of the light beam on each surface to be scanned and a lateral magnification in the x-axis direction from each reference point of deflection to each surface to be scanned is in a range from 2 to 3.

2. The optical scanning system according to claim 1, wherein the shape of the first scanning lens and the shape of the second scanning lens are identical with each other and are placed such that they are symmetric about the plane that is parallel to the x-axis and they-axis and contains a point O that is the middle point of a line segment connecting the point A1 and the point A2, and the shape of the third scanning lens and the shape of the fourth scanning lens are identical with each other and are placed such that they are symmetric about the plane that is parallel to the x-axis and the y-axis and contains the point O.

3. The optical scanning system according to claim 1, wherein each of the third scanning lens and the fourth scanning lens includes two lenses stacked in the x-axis direction, each of the two lenses having an object-side surface and an image-side surface.

4. The optical scanning system according to claim 1, the object-side surface of each of the first scanning lens and the second scanning lens is not a concave surface, of which an average value of absolute values of radius of curvature in an area on which a light beam is reflected in a cross section cut by an x-z plane is 200 millimeters or smaller.

5. The optical scanning system according to claim 1, wherein the optical scanning system further comprises third and fourth light sources and is configured such that a third light beam emitted by the third light source is reflected by the polygon mirror and passes through the first scanning lens and the third scanning lens and a fourth light beam emitted by the fourth light source is reflected by the polygon mirror and passes through the second scanning lens and the fourth scanning lens,
wherein a reference point of deflection of the third light beam agrees with P1, a reference point of deflection of the fourth light beam agrees with P2 and when θ3 represents an acute angle that a projection of the principal ray of the third light beam onto a plane containing the x-axis and the y-axis forms with the y-axis and θ4 represents an acute angle that a projection of the principal ray of the fourth light beam onto a plane containing the x-axis and the y-axis forms with the y-axis,
$$\frac{h 2}{2.2} \leq ( 2 \cdot L 1 + L 2 + {L}_{p 12} ) \cdot tan θ 3 \\ \frac{h 1}{2.2} \leq ( 2 \cdot L 2 + L 1 + {L}_{p 12} ) \cdot tan θ 4$$
are satisfied and
wherein a light beam emitted by each light source is substantially focused at each reference point of deflection in the direction corresponding to the x-axis direction of the light beam on each surface to be scanned and a lateral magnification in the x-axis direction from each reference point of deflection to each surface to be scanned is in a range from 2 to 3.

6. The optical scanning system according to claim 1, wherein an effective scan size on each surface to be scanned of each of the light beams emitted by the light sources is 230 millimeters or smaller.

7. The optical scanning system according to claim 1, wherein the optical scanning system further comprises an element for receiving light placed between each light source and the polygon mirror and is configured such that a light beam is converged in the direction corresponding to the y-axis direction of the light beam on each surface to be scanned after having passed through the element for receiving light.
